(19) United States
(12) Patent Application Publication
(10) Pub. No.: US 2017/0118591 A1
(43) Pub. Date: Apr. 27, 2017

(54) Configuring and Managing Mobile Devices in Predefined Geographic Locations

(71) Applicant: Aegex Technologies, LLC, Atlanta, GA (US)

(72) Inventors: Andre F.A. Fournier, Marietta, GA (US); Thomas P. Ventulett, Atlanta, GA (US)

(73) Assignee: Aegex Technologies, LLC, Atlanta, GA (US)

(21) Appl. No.: 15/226,911

(22) Filed: Aug. 2, 2016

Related U.S. Application Data
(60) Provisional application No. 62/200,036, filed on Aug. 2, 2015.

(51) Int. Cl. H04W 4/02

(52) U.S. Cl. CPC H04W 4/021; H04W 4/04

(57) ABSTRACT

Systems and methods for controlling operation of a mobile device when the mobile device is in a predefined geographic location characterized as being a hazardous, dangerous, or remote working environment. A device management policy or configuration data file is associated with the predefined geographic location and defines predetermined actions that will be performed by the mobile device when the mobile device enters and remains in the predefined geographic location. Once the mobile device enters the predefined geographic location, the device management policy is accessed, normal operation of the mobile device is interrupted, and the predetermined actions required by the policy are performed. The predetermined actions are intended to reduce risks to the user of the mobile device, increase safety, preserve battery life and essential functions of the mobile device, and maintain communication with the user while the user remains in the hazardous or remote environment.

### CROSS REFERENCE TO RELATED APPLICATIONS

This patent application claims priority benefit under 35 U.S.C. §119(e) to U.S. Prov. Pat. Appl. No. 62/200,036, entitled “Configuring and Managing Mobile Devices to Communicate Automatically in Different Environments,” filed Aug. 2, 2015, which is incorporated herein by reference in its entirety.

### FIELD OF THE PRESENT TECHNOLOGY

The systems, methods, and devices described herein relate generally to configuring and managing mobile devices to over-ride normal operations and to perform specific, predetermined actions when being used in predefined geographic locations. More specifically, the systems and methods enable mobile devices to be configured and managed automatically to perform desired actions that help protect, monitor, and communicate with the user of the mobile device when the user is working in hazardous, remote, and/or dangerous environments.

### BACKGROUND OF THE PRESENT TECHNOLOGY

A single individual worker, today, located in a hazardous and/or remote area of the world, may be required periodically to report in to a monitoring system or call center with location, work status, or safety information. To ensure the safety of their employees or resources, it is often necessary for companies to be able to contact their people and/or resources to notify them of an emergency or critical situation (e.g. an “event”) and require the workers and/or resources to act upon the event. The required action may include, for example, attending to the emergency, evacuating personnel or resources, assisting another employee, repairing resources or equipment, turning off equipment, or reconfiguring equipment.

Today, conventional methods and systems require companies periodically to contact their work force and/or resources to track them and ensure they are safe and in good condition. Companies have many employees and resources located in many different locations and, unfortunately, because of travel and deployment in remote locations, the company does not always have access to the employee. So, if an emergency arises, it may be impossible to contact everyone in the area. In addition, it may be impossible even to know which of their employees are located in a specific area of concern.

The cost of contacting their employees may be prohibitive because the only communication system available may be satellite communication. In certain locations, mobile devices require more power to communicate because of the distance to the communication stations.

Therefore, there is a need for systems and methods that provide the ability automatically to configure a mobile device to perform predetermined actions when the device is used in a predefined geographic location that represents a hazardous, dangerous, or remote location. Other factors, including the type of mobile device involved, are also considered when establishing a device management policy that defines the one or more predetermined actions that should be performed by the mobile device when it enters, remains within, and subsequently exits a predefined geographic location.

There is a further need for systems and methods that enable a company to monitor and communicate with their workers and/or resources when they are located within such predefined geographic locations. Such systems and methods preferably minimize the communication session and use the least expensive (or safest) method of communicating based on the hazards, danger, or remoteness of the relevant location. Such systems and methods preferably enable an employee and employer to remain in contact automatically, to request or determine location of the user, capture day and time stamp information of each contact, and request or obtain status information back from their employee/user of the mobile device.

As used herein, the term “mobile device” is intended to include and encompass, but not be limited to, any type of hand-held, portable, mountable, wearable, or similar computing or communication device that is usable by an employee when working in a hazardous, dangerous, or remote environment. Such devices include, but are not limited to, cell phones, mobile phones, smart phones, push-to-talk devices, personal digital assistants (PDAs), text or email dedicated devices, general computers, laptops, electronic maps or other GPS location devices, vehicle dashboard screens, electronic reading devices, multimedia equipment, data tablets, electronic eyewear, wearable sensory or sensory-enhancement equipment, and any other computing or communication device that may be used by an employee when working in a hazardous, dangerous, or remote environment, hereinafter referred to as a predefined geographic location.

As used herein, the term “predefined geographic location” is intended to include and encompass, but not be limited to, any physical geographical location that can be defined by physical or virtual boundaries. Preferably, the boundaries are capable of being determined based on latitudinal and longitudinal coordinates, physical walls or structures (whether man-made or natural), by use of sensors or other electronic devices, and the like.

Preferably, the ability to determine when a mobile device is entering, currently within, and subsequently exiting a predefined geographic location can be determined by the mobile device itself and/or by remote computing or communication equipment based on global positioning system (GPS) data or communication triangulation techniques based on data/phone towers and/or satellites in communication with such mobile device or combinations of the above.

Further advantages, features, and improvements provided by the present invention, when compared to conventional systems, will become apparent to one of ordinary skill in the art after reviewing the remainder of the present application with reference to the drawings, detailed description, and claims which follows.

The above needs and features, as well as additional aspects and business applications, are disclosed herein and will become readily apparent to one of ordinary skill in the art after reading and studying the following summary, the detailed description of preferred embodiments, and the claims included hereinafter.

### SUMMARY OF THE PRESENT TECHNOLOGY

The present inventions described herein relate generally to systems, methods, and devices for monitoring, managing, controlling, and making effective use of mobile communication devices within a vehicle and, more particularly, to accurately identifying vehicular drivers, collecting vehicular status and driving data, and interfacing with one or more mobile communication devices within the vehicle regarding the same. Briefly described, aspects of the present invention include the following.

In a first aspect of the invention, a system for controlling operation of a mobile device when the mobile device is in a predefined geographic location is disclosed. The mobile device has at least one processor, memory storage, and a non-transitory computer-readable medium that is usable by the at least one processor and is operatively coupled to the memory storage, wherein the computer-readable medium having stored thereon a sequence of instructions that when executed by the at least one processor causes the mobile device to perform one or more predetermined actions. The system comprises: (a) in a database external to the mobile device, storing a device management policy associated with the predefined geographic location, the device management policy defining the one or more predetermined actions to be performed by the mobile device when the mobile device is in the predefined geographic location, wherein the predefined geographic location has one or more hazardous, dangerous, or remote characteristics and wherein the one or more predetermined actions are established based on the one or more hazardous, dangerous, or remote characteristics of the predefined geographic location; (b) storing the device management policy in the memory storage of the mobile device; (c) determining if the mobile device is in the predefined geographic location; (d) thereafter, if the mobile device is in the predefined geographic location, accessing the device management policy stored in the memory storage; and (e) causing the mobile device to perform the one or more predetermined actions as defined by the device management policy associated with the predefined geographic location.

In a feature, the predefined geographic location is an area having defined boundaries. The term “predefined geographic location” is intended to include and encompass, but not be limited to, any physical geographical location that can be defined by physical or virtual boundaries. Preferably, the boundaries are capable of being determined based on latitudinal and longitudinal coordinates, physical walls or structures (whether man-made or natural), by use of sensors or other electronic devices, and the like.

In another feature, the device management policy comprises a configuration data file that is designed to be read and acted upon by the mobile device.

In a further feature, the one or more hazardous, dangerous, or remote characteristics indicate one or more of: risk of explosion, risk of accidental damage, risk to life, and availability of communication channels associated with the predefined geographic location. Preferably, the one or more predetermined actions are established to reduce risk of explosion, reduce risk of accidental damage, reduce risk to life, identify communication channels available within the predefined geographic location, and maintain communication between the user, the mobile device, and a remote server.

In another feature, the predetermined actions are further based on one or more of: the characteristics of the mobile device, the identity of the user, the number of personnel other than the user working in the predefined geographic location, the time of day, the date, the amount of time the user has been in the predefined geographic location, whether there has been a successful communication between the mobile device and a remote server, an amount of time that has elapsed since the successful communication, whether there has been input received by the mobile device from the user, and an amount of time that has elapsed since the input was received by the mobile device from the user.

Additionally, the predetermined actions comprise one or more of: placing the mobile device in a hibernation state, placing the mobile device in a low power setting, causing the mobile device to send a data communication to a remote server, determining a preferred communication channel for sending the data communication to the remote server, requesting that the mobile device receive an input from the user, placing the mobile device in a normal operating state, determining battery life of the mobile device, activating an emergency strobe light on the mobile device, and determining if the mobile device is still in the predefined geographic location.

In further feature, determining if the mobile device is in the predefined geographic location is based on (a) the global positioning system (GPS) coordinates of the mobile device and of the predefined geographic location, (b) input received by the mobile device from a remote server; (c) input received by the mobile device from the user; (d) input received by the mobile device from sensors or transceivers associated with the predefined geographic location; or (e) one or more of the above alone or in combination with each other.

In another feature, the system further includes determining when the mobile device is entering or exiting the predefined geographic location.

In a feature, storing the device management policy in the memory storage of the mobile device further comprises uploading the device management policy from the external database to the mobile device.

In some embodiments, the system further comprises modifying the device management policy based on a change to the one or more hazardous, dangerous, or remote characteristics of the predefined geographic location. Particularly if such change occurs while the user is in the predefined geographic location or if the change occurs after the previous policy was stored in the remote database or previously uploaded to the mobile device. Preferably, the modified device management policy is uploaded from the external database to the mobile device.

In yet a further feature, the device management policy further includes one or more predetermined actions to be performed by the mobile device when it has been determined that the mobile device has exited the predefined geographic location.

The present inventions also encompass computer-readable medium having computer-executable instructions for performing methods of the present invention, and computer networks and other systems that implement the methods of the present invention.

Further advantages, features, and improvements provided by the present invention, when compared to conventional systems, will become apparent to one of ordinary skill in the art after reviewing the remainder of the present application with reference to the drawings, detailed description, and claims which follows.

The above needs and features, as well as additional aspects and business applications, are disclosed herein and will become readily apparent to one of ordinary skill in the art after reading and studying the following summary, the detailed description of preferred embodiments, and the claims included hereinafter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In addition, further features and benefits of the present technology will be apparent from a detailed description of preferred embodiments thereof taken in conjunction with the following drawings, wherein similar elements are referred to with similar reference numbers, and wherein:

FIG. 1 is a high level system view of one embodiment of the present invention;

FIG. 2 is a conceptual view of the software structures used by servers and mobile devices in the system associated with the embodiment of FIG. 1;

FIG. 3 is a flow chart illustrating a server-based configuration request process used with the system of FIG. 1;

FIG. 4 is a flow chart illustrating a mobile device initiated configuration request process used with the system of FIG. 1;

FIG. 5 is a flow chart illustrating a user initiated configuration request process used with the system of FIG. 1;

FIG. 6 is a flow chart illustrating a server based configuration response process used with the system of FIG. 1;

FIG. 7 is a flow chart illustrating a server based configuration assignment process used with the system of FIG. 1;

FIG. 8 is a flow chart illustrating a mobile device monitoring process used with the system of FIG. 1; and

FIG. 9 is a flow chart illustrating a server based monitoring process used with the system of FIG. 1.

### DETAILED DESCRIPTION OF PREFERRED EMBODIMENTS

Before the present technologies, systems, products, articles of manufacture, apparatuses, and methods are disclosed and described in greater detail hereinafter, it is to be understood that the present technologies, systems, products, articles of manufacture, apparatuses, and methods are not limited to particular arrangements, specific components, or particular implementations. It is also to be understood that the terminology used herein is for the purpose of describing particular aspects and embodiments only and is not intended to be limiting.

As used in the specification and the appended claims, the singular forms “a,” “an” and “the” include plural referents unless the context clearly dictates otherwise. Similarly, “optional” or “optionally” means that the subsequently described event or circumstance may or may not occur, and the description includes instances in which the event or circumstance occurs and instances where it does not.

Throughout the description and claims of this specification, the word “comprise” and variations of the word, such as “comprising” and “comprises,” mean “including but not limited to,” and is not intended to exclude, for example, other components, integers, elements, features, or steps. “Exemplary” means “an example of” and is not necessarily intended to convey an indication of preferred or ideal embodiments. “Such as” is not used in a restrictive sense, but for explanatory purposes only.

Disclosed herein are components that can be used to implement the technologies, systems, products, articles of manufacture, apparatuses, and methods described herein. These and other components are disclosed or described herein, and it is to be understood that when combinations, subsets, interactions, groups, etc. of these components are disclosed that, while specific reference to each various individual and collective combinations and permutation of these may not be explicitly disclosed, each is specifically contemplated and described herein, for all technologies, systems, products, articles of manufacture, apparatuses, and methods. This applies to all aspects of this specification including, but not limited to, steps in disclosed methods. Thus, if there are a variety of additional steps that can be performed, it is understood that each of the additional steps can be performed with any specific embodiment or combination of embodiments of the disclosed technologies, systems, products, articles of manufacture, apparatuses, and methods.

As will be appreciated by one skilled in the art, embodiments of the present technologies, systems, products, articles of manufacture, apparatuses, and methods may be described below with reference to block diagrams and flowchart illustrations of methods, systems, processes, steps, and apparatuses. It will be understood that each block of the block diagrams and flow illustrations, respectively, support combinations of means for performing the specified functions and/or combinations of steps for performing the specified functions.

The present systems and methods enable automatic configuration of actions to be performed by a mobile device based on the type of environmental location in which the device is being used. The present systems and methods further enable such mobile devices (and their users) to be monitored and to remain in communication while users of the mobile device (e.g. personnel and employees) are working in hazardous, dangerous, or remote locations or environments. The systems and methods use servers, databases, call centers in communication with mobile devices being used in hazardous, dangerous, or remote locations or environments. Software resides on the servers and on the mobile devices to implement the device management policies, which define the configuration and action items to be performed by the mobile device when the mobile device is being used in a predefined geographic location. Policies are also established for the remote servers and call centers that are used to monitor and communicate, as necessary or desired, with the mobile devices being used in such environments.

In preferred embodiments, device management policies are maintained for predefined geographic locations. Such policies define what actions are to be performed by the mobile device and also by the remote servers and call centers that are intended to remain in communication and contact with such mobile devices. Preferably, such policies are updated and uploaded to the mobile device and also to the remote servers and call centers at predetermined times or in response to specific requests initiated by the server, the mobile device, or the user of a mobile device. Preferably, such policies are uploaded in advance—either well in advance of entering a predefined geographic location or, automatically, when the mobile device is determined to be approaching, entering, currently within, or exiting such locations.

In practice, such mobile devices are intended to be used in environments in which it is critical to monitor, among other things, battery status, communication link availability and status which are necessary to enable monitoring and open communication channels between device users and their employers located remotely from the hazardous environments. Such monitoring helps ensure the safety of employees and helps ensure that lines of communication remain open to such employees in case it is necessary to provide emergency information or directions to such employees when they are located in hazardous, dangerous, or remote working environments or locations.

An exemplary embodiment includes systems and methods to determine at least one method of communication between the call center and the mobile device. Such communication methods include but are not limited cellular, satellite, or Wi-Fi wireless based communication technologies. The communication method may be based on full duplex communication or one-way communication, similar to a pager or broadcast communication. The communication channels include, but are not limited to, Radio Interface Link control messages that may be utilized by such devices, Internet based communication, push-to-talk communications, or conventional emergency communication channels.

The communication method helps to ensure safety and open lines of communication whether a single employee or numerous employees are working in such an environment. The communications may provide direction or action to be taken based on an event or situation, or such communications may request and/or seek to obtain status of the user or the mobile device of the user. Preferably, any communications are date and time stamped and location information, if available or determinable is provided or obtained when necessary.

In preferred embodiments, the systems and methods wait a predetermined interval between routine communications to preserve battery life, minimize resource usage and allocation. In emergency situations, it may be unnecessary or undesirable to impose wait times. In addition, in non-emergency or unknown situations, it may be desirable for the system or the policy to require periodic “check-in” communications—especially if a prior check-in communication was not able to be transmitted or received. Some “check-in” communications may only require an automated response by the mobile device to verify its status and location. Other check-in communications may require that the user interact with the mobile device to verify the mental and/or physical well being of the user. Depending on whether a communication is emergency or high priority or whether it is deemed routine or low priority, the system can use less expensive communication protocols to preserve device battery (for lower priority communications) or more expensive communication protocols (for higher priority or emergency communications).

The systems and methods disclosed herein provide numerous benefits, including but not limited to the following: (1) automated process to ensure the safety of employees based on their location and the environmental elements or locations in which they are working; (2) automated process to configure devices based on work orders, locations and environmental conditions; (3) using integrated technologies, such as GPS tracking and mapping, to enable mobile devices to be configured differently for use in different locations; (4) improving the safety and monitoring of employees working in hazardous, dangerous, or remote environments; (5) improving and monitoring available communication channels and making efficient use of the same based on known communication capabilities in predefined locations and based on dynamically changing conditions that may be occurring in such locations; (6) emergency communications priority message handling, and (6) maximizing efficiency of mobile devices being used in the field to take advantage of GPS, battery, and available communication links without unnecessarily taxing the mobile device and unnecessarily depleting battery life, which could become a critical resource when working in a hazardous, dangerous, or remote location.

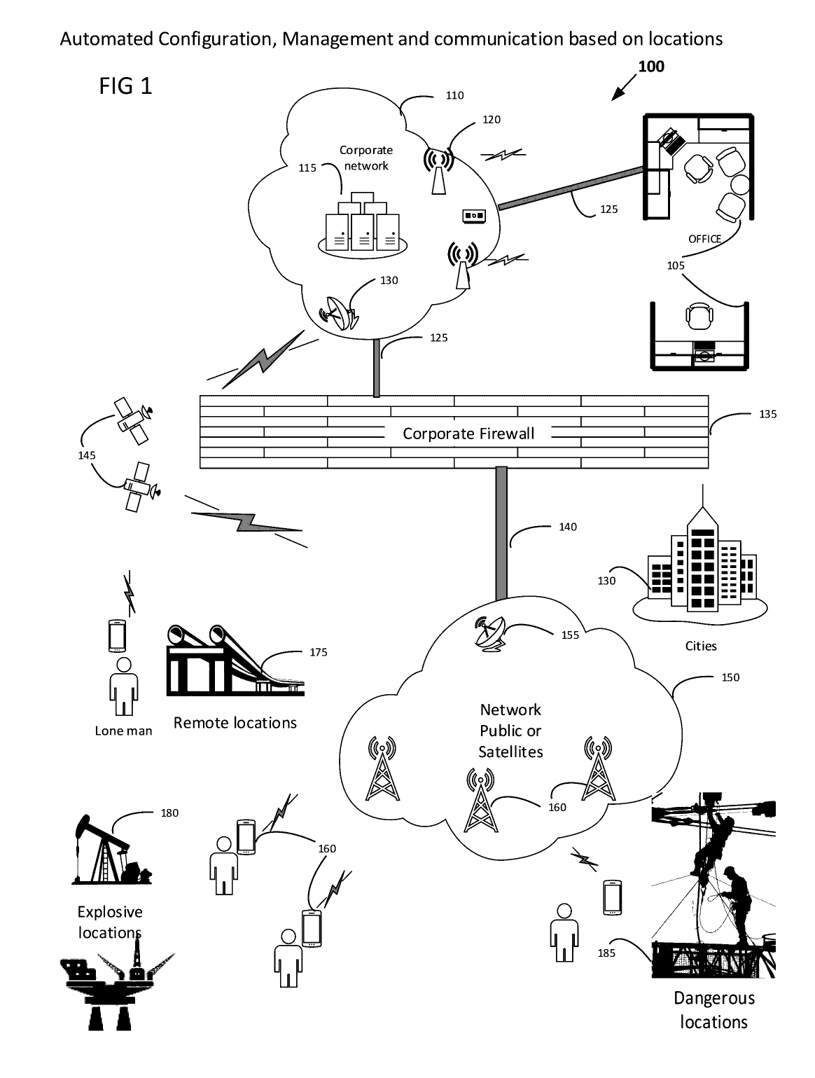

Referring now to the drawings, in which like numerals illustrate like elements throughout the several views, FIG. 1 is a conceptual representation 100 of the working environments of a typical company and the range of conditions within which their employees may work. The drawing illustrates workers in different environments and illustrates different communication channels that are typically available for establishing and maintaining communication between the company and its workers.

For example, many employees just work in conventional offices 105 in which employees can meet and perform daily work. The company typically uses a conventional, corporate private network 110 that includes servers and database systems 115, which, in the present invention, are used to create, manage, and store device management policies and configuration data associated with predefined geographic locations in which their employees may be asked to work or visit. The servers and database systems 115 also store other data, such as details about each predefined geographic location, what characteristics make it hazardous, dangerous, or remote, what its boundaries are, whether they are natural or virtual, whether those boundaries are defined solely by GPS coordinates or whether they are identified by use of sensors, RFID devices, beacons, transmitters, transceivers, and the like. Additional information about which employees or personnel are there or likely to be there at predetermined times and dates. The servers and database systems 115 also maintain information, such as UserIDs, deviceIDs, passwords, mobile device characteristics and capabilities and other information that is necessary to authenticate communications, establish and maintain communications, and establish device management policies that take into account not only the location to which an employee is going but also details about the user and the mobile device of the user that may impact or modify the types of action items that ought to be performed when the user is visiting a specific location.

The company's private network uses conventional communication channels, including wireless systems 120, landline systems 125, and satellite systems 130, or a combination of these interfaces. The private network connection enables the employees to access the company's private network and/or public network. The company's private network is protected and secured by the corporate firewall 135. The firewall provides protection to the company's network and employees from external malicious elements using conventional technologies.

The company uses conventional communication channels to send and receive configuration information and handle other data communications between the company and its employees and their mobile devices. For example, the company communicates with the public networks using the public network infrastructure 150 that includes hardwire landlines 140, Fiber loop, T1 technologies, satellites 155, cell towers 160, and wireless interfaces 145. The public networks enable the company and its employees to configure, monitor, and communicate with mobile devices 160 of their employees. Employees use their mobile devices 160 to communicate when they visit or work in locations, which may be remote locations 175, explosive/hazardous locations 180, or otherwise dangerous locations 185.

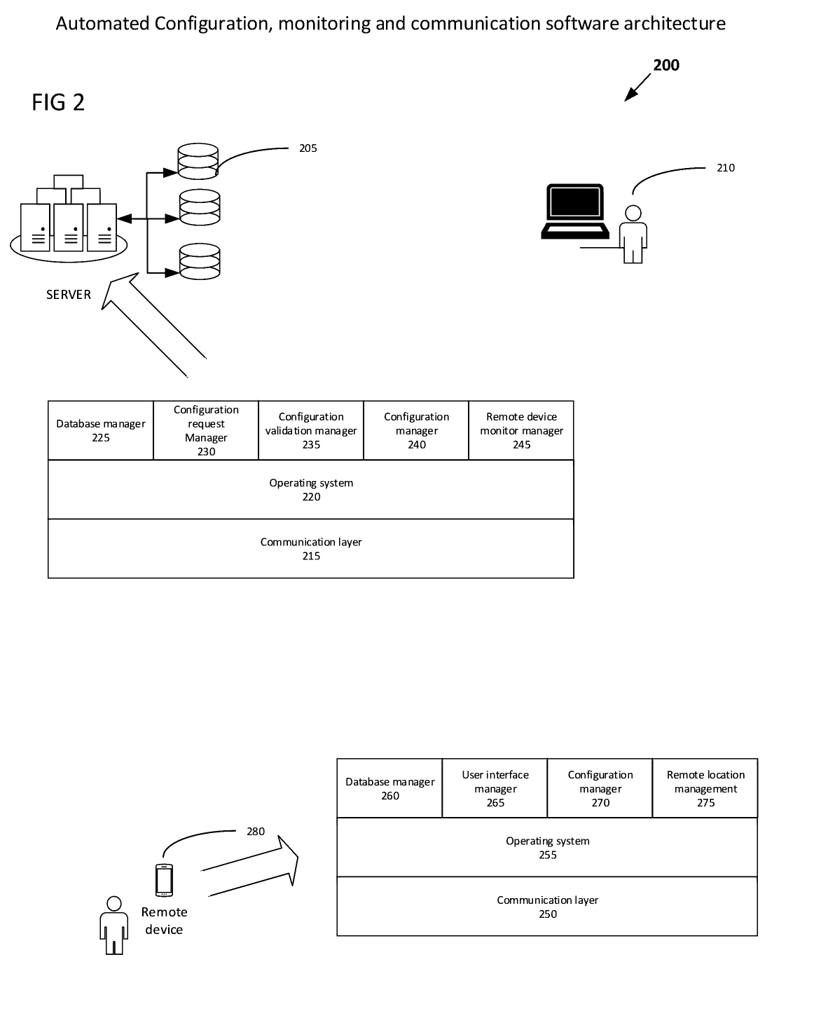

FIG. 2 is a conceptual representation 200 of typical software structures used to implement and execute the processes described herein. Some of software resides in the company's servers and database systems and reciprocating software resides on the employee's mobile devices. The software uses existing operating systems and hardware technologies. The exemplary software architecture is preferably implemented using development tools which are supported by existing operating systems, such as but not limited to Microsoft Windows™, Android™, IOS™ Apple, and utilize conventional communication protocols, such as but not limited to TCP/IP, UDP, SMS, and e-mails communications.

The company's private network 205 includes servers and databases, which can be access by its employees using a desktop or laptop computer 210 or using a mobile device 280.

The software structure for the private network 205 includes a conventional communication layer 215, which provides the necessary hardware management and protocols software. The hardware and the protocol software handle Ethernet, modems, TCP-IP, UDP, and HTTP type communications. The software structure is managed by an operating system 220, such as those offered and sold under the following brands: Unix™, Microsoft Windows™, and Apple™.

The exemplary configuration, management, and monitoring software described herein is managed by the operation system and communication layer. The exemplary software consists of database manager 225, this database manager enables the company to store, add, delete, modify, view, and print all of its critical records, such as its predefined geographic location list, details and boundary data associated with each predefined geographic location, employee list with userID and password, mobile device details, incident storage and management. The database manager is accessible to selected employees through a secure log in.

The configuration request manager 230 manages all configuration request initiated but not limited to work order process, user intervention, time of day schedule. The configuration request manager uses the operating system to communicate with the configuration manager 240.

The configuration validation manager 235 is initiated when a user turns on a remote device or the user request a configuration change. The configuration validation manager uses the operating system and the communication layer to communicate with the remote mobile device. Once the configuration validation manager has validated the request, it uses the operating system to communicate with the configuration manager 240.

The configuration manager 240 uses the operating system to communicate with the database to obtain the required configuration information. The configuration manager prepares the configuration in a message format and communicates with the remote device using the operating system and communication layer.

The remote device monitor manager 245 monitors the remote devices through the operating system and communication layer. Upon receiving a message from a remote device, the remote device monitor manager updates the databases with the received information using the operating system. If the device monitor manager receives an alarm, the device monitoring manager uses the operating system and communication layer to contact specified agencies and personnel.

The exemplary automated configuration, monitoring and communication software also resides in remote mobile devices 280 and provides the necessary software functions to configure and monitor mobile devices and to enable communication with the company's private network.

The software structure for the mobile device 280 includes a conventional communication layer 250, which provides the necessary hardware management and protocols software. The hardware and the protocol software handle Ethernet, modems, TCP-IP, UDP, and HTTP type communications. The software structure is managed by an operating system 255, such as those offered and sold under the following brands: Unix™, Microsoft Windows™, and Apple™.

The database manager 260 enables the device to update and view its critical records all of its critical records, such as its predefined geographic location list and details and boundary data associated with each predefined geographic location.

The user interface manager 265 provides the functionality to interact with the remote device display and monitor the remote device buttons for input. The user interface manager formats the software messages to a readable and displayable format and monitors key depression for input. The configuration manager 270 receives, formats and stores the configuration information in memory. The configuration manager uses the operating system and the communication layer to communicate with the company's private network. The configuration manager uses the operating system to interface with the remote location management 275.

The remote location monitoring software uses the operating system and communication layer to communicate with the GPS. Using the GPS information, the remote location monitoring software uses the operating system to communicate with the database manager to verify the location of the mobile device. If the mobile device is located in a predefined geographical location, the remote location prompts the user for an acknowledgement and monitors the keyboard using the user interface manager. Once the cycle is completed the remote location manager uses the operating system and communication layer to communicate with the company's private network and send the mobile device information.

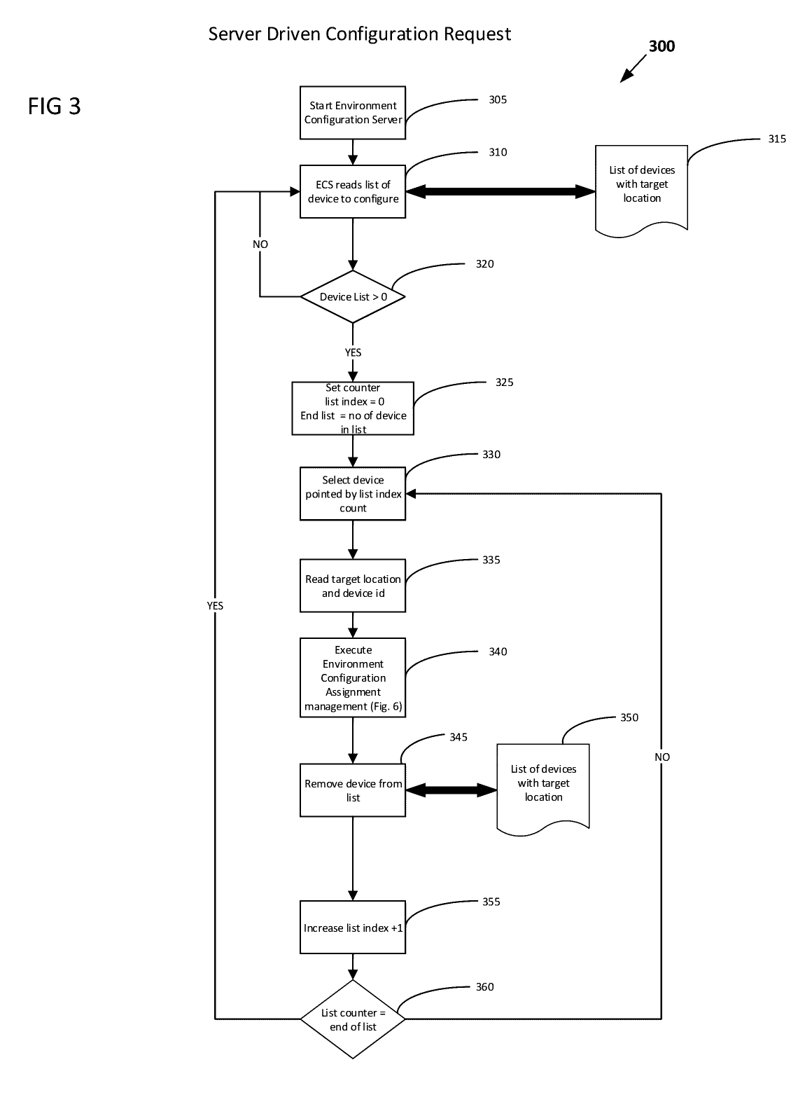

FIG. 3. is a block diagram illustrating an exemplary server-based configuration request system 300. The configuration request server may initiate configuration request based on company work orders, list of devices and associated locations, time of day access, or batch processing of requests. The company exemplary automated configuration request process flow chart 300 may be initiated (step 305) by numerous means including a user request or a time of day or part of the company's work order process.

The server reads the environment configuration list (step 310) and validates the list against the company's database (step 315) of target devices and locations. If there are no devices or locations identified in the list (step 320) the server returns to waiting for another initiation (step 310).

If the device or locations list contains valid devices with valid locations, the server will set the start and end pointers for the list (step 325) and start the process of requesting the configuration for each device. The server selects a device (step 330) based on the pointer in the list.

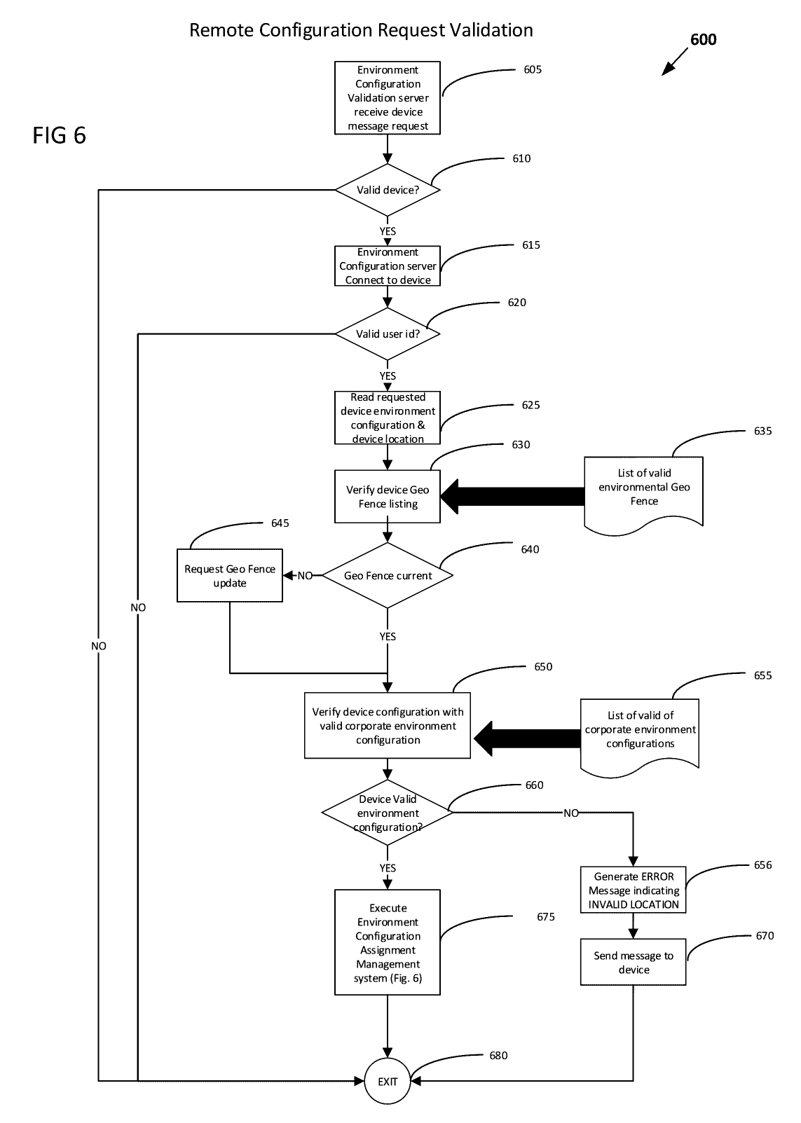

The server reads the target location and device ID (step 335) and executes the exemplary environment configuration management process (step 340), as depicted in FIG. 6. Once the device has received its configuration, the server removes the device (step 345) from the list and increments the pointer to the next device (step 355). Once the server has completed configuring all the devices (step 360) in the list, the process returns to read the next list (step 310).

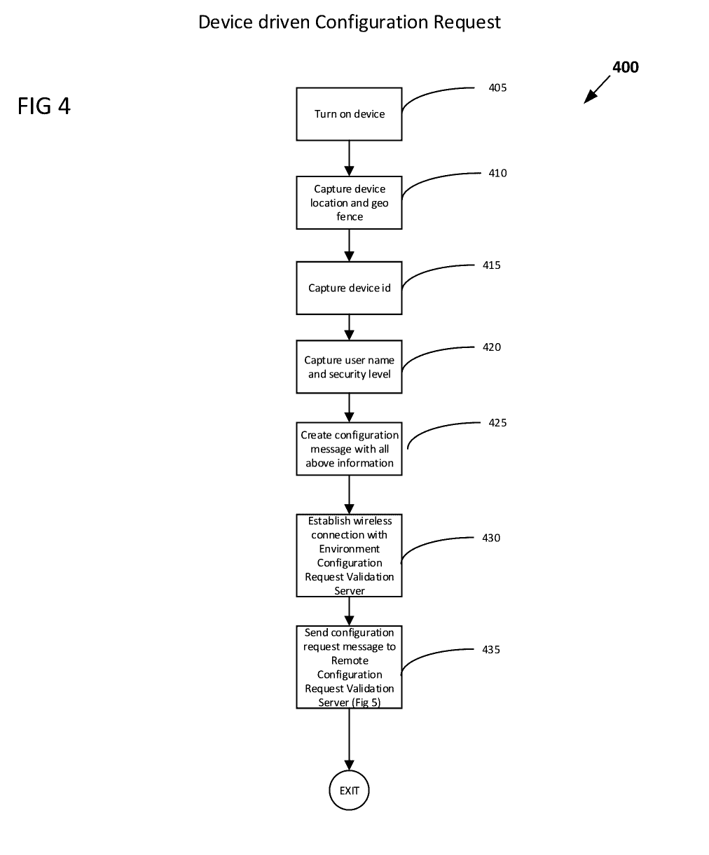

FIG. 4 is a block diagram illustrating an example of a remote configuration request 400 from a mobile device based on its location. An exemplary device driven process ensures mobile devices are properly configured when they are first used and the mobile device configuration is up to date and accurate. The exemplary device driven request is software which resides on the mobile device and is initiated when the user turns the mobile device ON.

Upon been turned on (step 405), the device captures its location and its predefined geographical location list (step 410). As part of the message creation, the device captures the device ID (step 415) and the name of the user and his/her security level (step 420). The device creates a message with the information it capture (step 425). The device establishes a connection with the server (step 430). The device and server exchange security messages and execute the device configuration validation (step 435), which is depicted in FIG. 6.

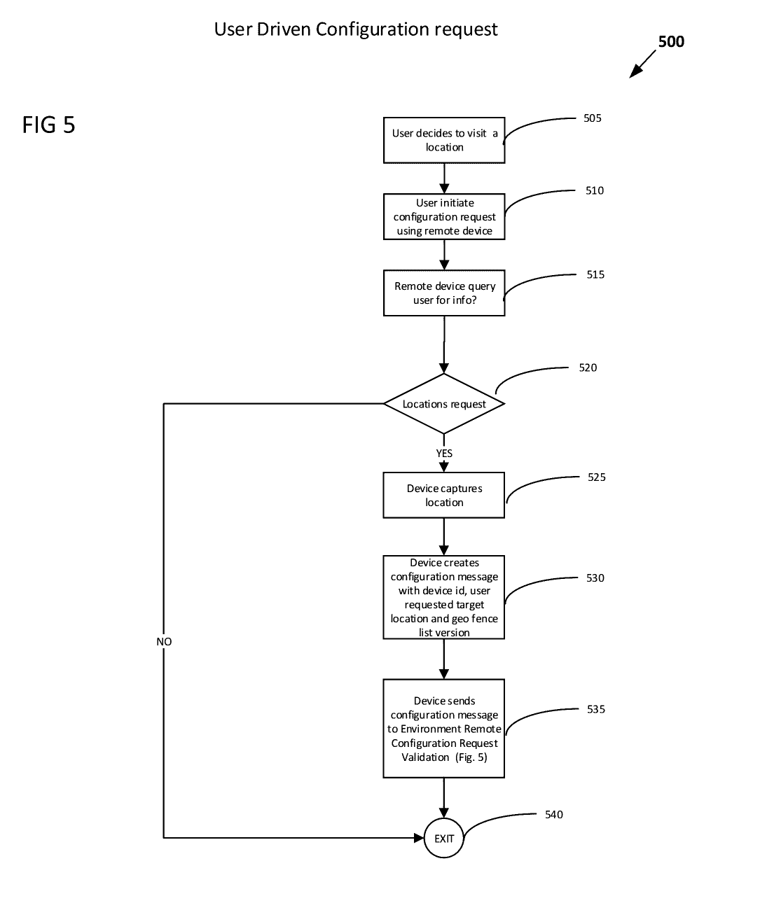

FIG. 5 is a flow chart 500 illustrating an example of a user configuration request when the user is planning to enter or travel to a company identified location with associated environmental elements. The exemplary process and flow 500 depicts a situation in which a user may want to update his/her mobile device with an up to date location list and associated policy configurations. The exemplary user driven request is software installed on the mobile device and is initiated when the user wants to update the mobile device with an up to date location list and associated policy configurations.

The user decides to update the mobile device (step 505) by initiating a configuration request session (step 510) with the mobile device. The device application queries the user for his/her user ID and information (step 515). The device queries the user for the location (step 520), and the user may enter a location or not. If the user does not provide a targeted location, the process EXITS (step 540).

If the user does provide a target location, the device captures the user entered location (step 525) and creates the configuration request message (step 530) with the user ID, security target location, and up to date location list. Device sends the message to the corporate private network, which executes the configuration request validation (step 535), as described in FIG. 6.

FIG. 6 is a flow chart 600 illustrating an exemplary process 600 that validates and acts upon a request for a policy configuration. This process is initiated by either a mobile device or by a user. The exemplary remote configuration request validation process is implemented in software which resides in the company's private network and is maintained and adheres to the company's IT services and related policies.

The exemplary process receives a message from a remote device (step 605) and validates the device ID (step 610) to ensure it meets the company security requirements. If the device ID is NOT valid, the server EXITS (step 680).

If the device ID is valid, the server connects to the device through existing communication technology. The exemplary process reads and deciphers the device's configuration request (step 625) and verifies the device's location list with the company's approved location list (step 635). If the device's list is NOT current (step 640), the server sets the request update flag (step 645) and continues the verifying the device configuration request (step 650).

If the device's list is current, the server verifies the device's configuration request (step 650) against the company's valid environmental configuration database (step 655). If the device's configuration request is NOT valid, the server creates an ERROR message (step 665) and sends the message to the device (step 670) and EXITS (step 680).

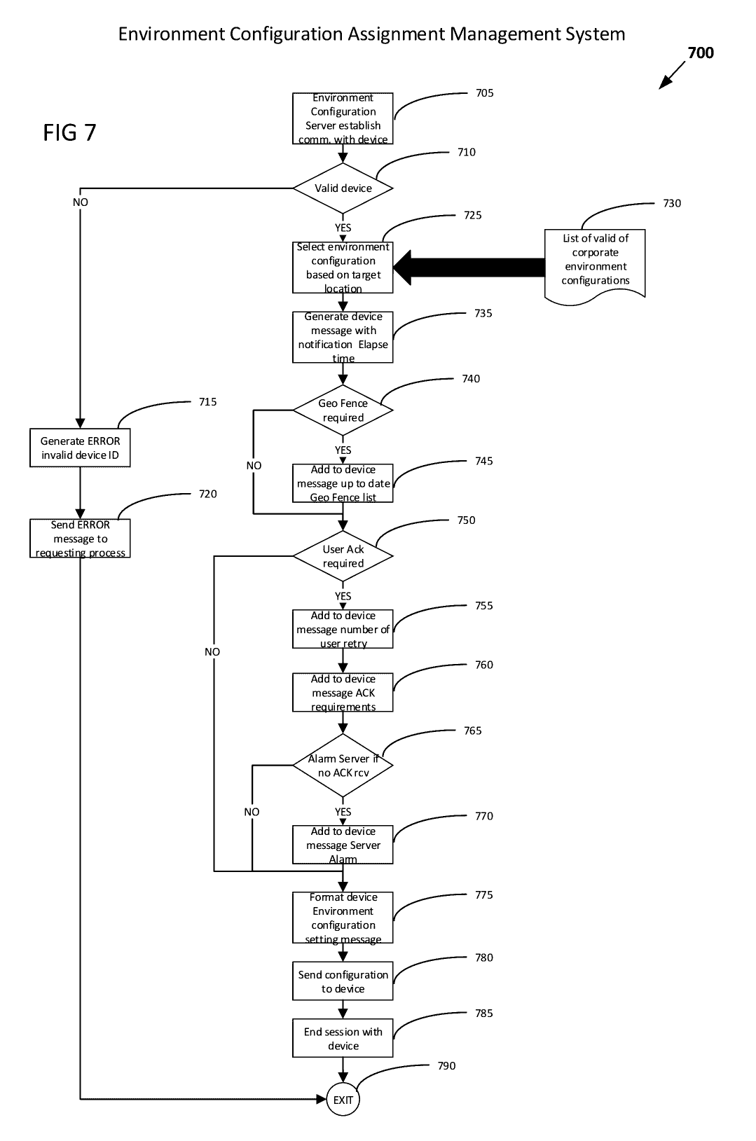

If the device configuration message is valid, the server executes the environment configuration assignment management exemplary process (step 675), as shown in FIG. 7, and then EXITS (step 680).

The exemplary environment configuration assignment management process 700, as shown in FIG. 7, establishes a connection with the device (step 705) and validates the device ID (step 710). If the device ID is invalid, the exemplary assignment process creates an ERROR message (step 720) and sends the message (step 725) to the appropriate error handling process and EXITS (step 795).

If the device ID is valid, the server selects (step 730) the target locations environmental configuration from the corporate list of valid environment configuration policies (step 735). The server creates the device message, based on the targeted location, sets the appropriate user request acknowledgement timing (step 740) and verifies that the device has the up to date location list (step 745). If the device does not possess the up to date location list, the server adds the up to date location listing to the device message (step 750) and moves to the next step.

If the device do have the up to date location list, the server verifies, using the target location configuration information, whether the target location requires a periodic user acknowledgement (step 750). The server then adds to the device message, the number of user retries (step 755) and the ACK configuration (step 760). Based on the target location, the server verifies if the user does not acknowledge the device prompt (step 765). If the target location requires an alarm to be generated when the user does not send an acknowledgement, the server add to the device message an ALARM setting (step 770).

When the device message is completely configured based on the target location, the configuration assignment server formats the device message (step 780) to maximize communication network and meet corporate security policy. The configuration assignment server sends the message to the device (step 785) using the established communication link and end the session with the device (step 790) and EXITS (step 795).

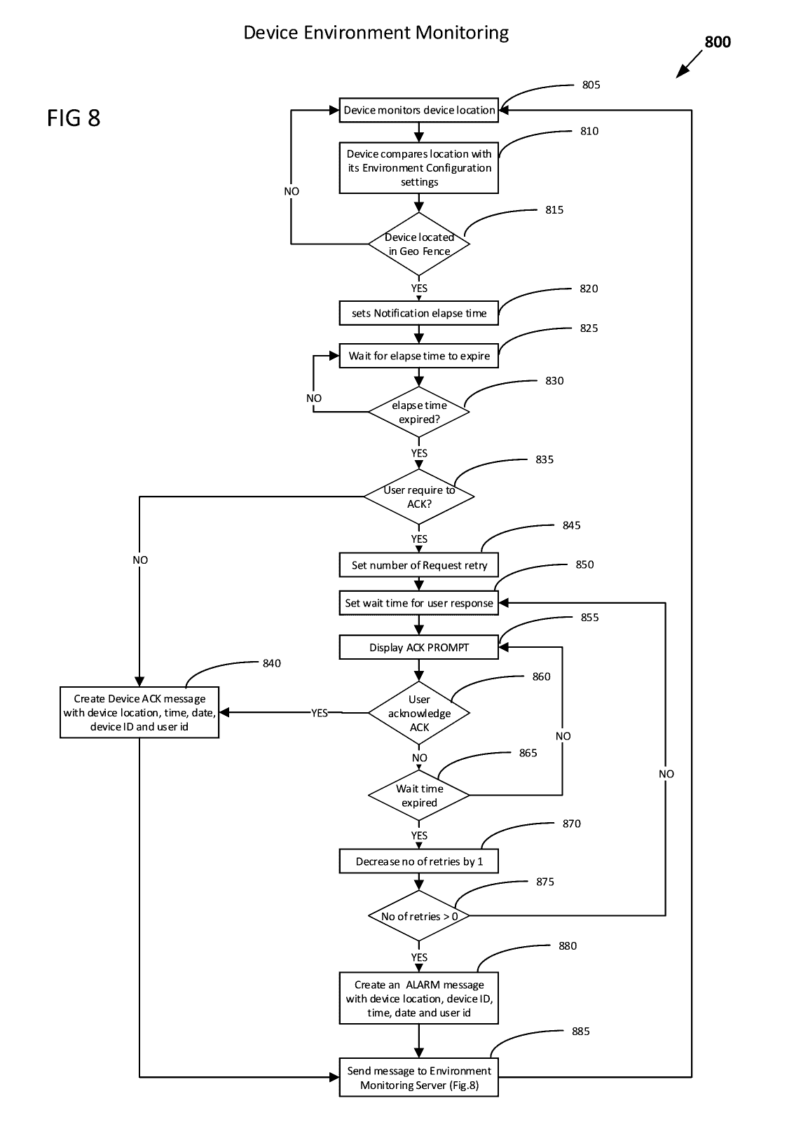

Another exemplary process in FIG. 8 illustrates the Device Environment Monitoring process and is initiated when the device enters target location with specific device configuration to ensure the safety and accessibility of the user. The exemplary device monitoring process 800 is software residing in the mobile device and is maintained and adheres to the company's IT services and related policies.

The device continuously monitors its location (step 805) by using the device GPS and its configured location listing. If the device moves its location, the process verifies its new location against its stored configured location list (step 810). If the device does not enter a stored configured location, the device returns to its monitoring (step 805).

If the device enters a configured location, the process uses the configured target locations configuration (step 815) and sets the notification elapse time (step 820). The device uses elapse configuration time to prompt the user for an acknowledgement. This exemplary process provides the company a method to monitor and receive either an automated or a user response for employees in remote locations.

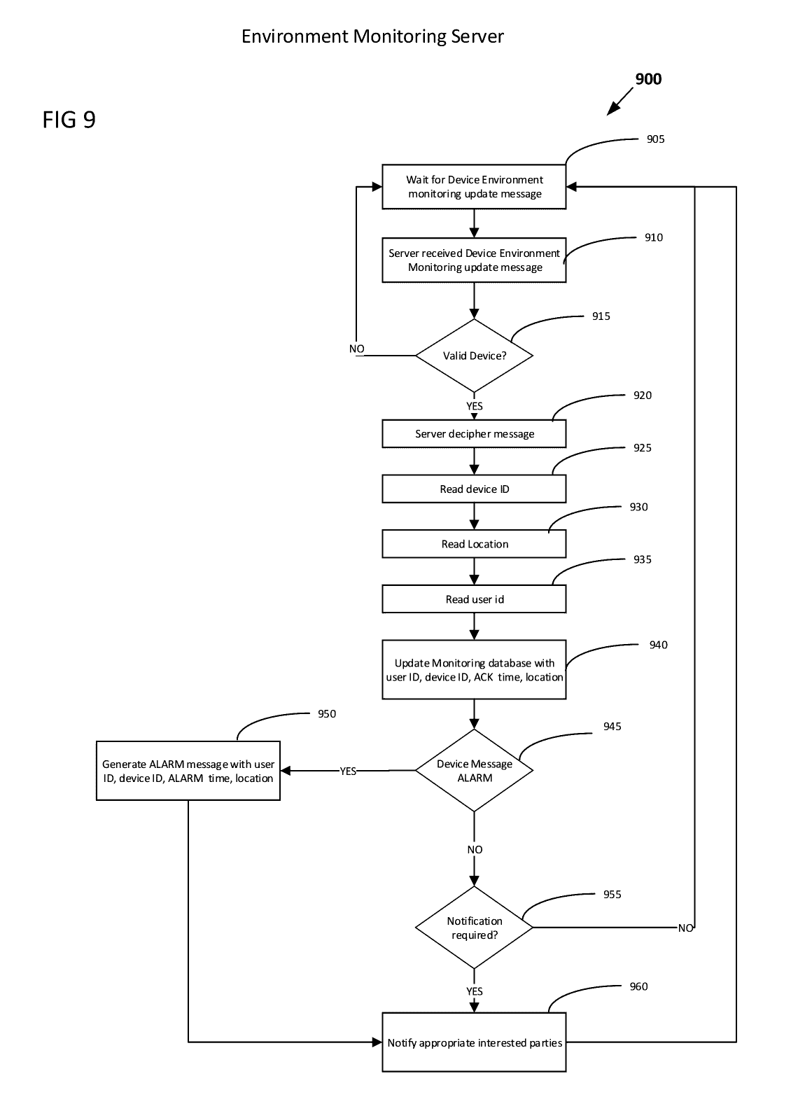

The device monitors the elapse time to expire using a loop between steps 830 and 835. When the elapse time expires, the device, based on the target location configuration, verifies if the ACK message (step 835) is an automatic message or requires user intervention. If the ACK message is automated, the device captures the device ID, its location, and user ID (step 840) and send the ACK message to the environment monitoring system (step 885), as depicted in FIG. 9

If the ACK message requires user interaction, the device sets the number user RETRY (step 845) and sets the wait time for the user response (step 850). The device displays the ACK request prompt (step 855) and monitors the user intervention (step 860) for an acknowledgement and waits for the elapse time expiration (step 865). If the user acknowledge the device prompt, the device generates device ACK message (step 840) consisting of the user ID, device location, device ID, time and date, and sends to the environment monitoring system (step 885), as depicted in FIG. 9

If the device does not receive a user response within the allotted time, the device verifies how many tries have been executed (step 870). If the number of tries is not exhausted, the device repeats the process from steps 855 to 865. If the device has completed the number of tries, the device generates an ALARM message with device location, device ID, time, date and user ID (step 880) and sends to the environment monitoring system (step 885), as depicted in FIG. 9

As shown in FIG. 9, an exemplary configuration assignment process 900 is software, which resides in the company's private network and is maintained and adheres to the company's IT services and related policies.

The exemplary configuration assignment process waits for a device environment monitoring message (step 905) and upon receiving such message the server reads the content of the message (step 910). The server validates the device ID (step 915) to ensure it is an approve device. If the device is not valid, the server returns to monitoring messages (step 905). If the device ID is valid, the server deciphers the message (step 920) and reads the device ID (step 925), the location of the device (step 930) and the device user ID (step 935).

The server updates the monitoring database with the user ID, device ID, ACK time and date and location (step 940). The server verifies if the device message requires the generation of an ALARM message (step 945). If server determines an ALARM message is required, the server creates an ALARM Message with user ID, device ID, location, time and date (step 950) and sends the ALARM message to the appropriate organizations and agencies (step 960).

If the server determines no ALARM message is required, the server verifies if a non-alarm notification is required (step 955) and, if there is no requirements to send a no-alarm message, the server returns to monitoring for device messages (step 905). If the server determines there is a requirement for non-alarm notification, the server sends a message to the identified organization (step 960) and the server returns to monitoring for device messages (step 905).

In view of the foregoing detailed description of preferred embodiments of the present invention, it readily will be understood by those persons skilled in the art that the present invention is susceptible to broad utility and application. While various aspects have been described herein, additional aspects, features, and methodologies of the present invention will be readily discernable therefrom. Many embodiments and adaptations of the present invention other than those herein described, as well as many variations, modifications, and equivalent arrangements and methodologies, will be apparent from or reasonably suggested by the present invention and the foregoing description thereof, without departing from the substance or scope of the present invention. Furthermore, any sequence(s) and/or temporal order of steps of various processes described and claimed herein are those considered to be the best mode contemplated for carrying out the present invention. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in various different sequences and orders, while still falling within the scope of the present inventions. In addition, some steps may be carried out simultaneously. Accordingly, while the present invention has been described herein in detail in relation to preferred embodiments, it is to be understood that this disclosure is only illustrative and exemplary of the present invention and is made merely for purposes of providing a full and enabling disclosure of the invention. The foregoing disclosure is not intended nor is to be construed to limit the present invention or otherwise to exclude any such other embodiments, adaptations, variations, modifications and equivalent arrangements, the present invention being limited only by the claims appended hereto and the equivalents thereof.

We claim:

1. A system for controlling operation of a mobile device when the mobile device is in a predefined geographic location, the mobile device having at least one processor, memory storage, and a non-transitory computer-readable medium that is usable by the at least one processor and is operatively coupled to the memory storage, the computer-readable medium having stored thereon a sequence of instructions that when executed by the at least one processor causes the mobile device to perform one or more predetermined actions, comprising:
in a database external to the mobile device, storing a device management policy associated with the predefined geographic location, the device management policy defining the one or more predetermined actions to be performed by the mobile device when the mobile device is in the predefined geographic location, wherein the predefined geographic location has one or more hazardous, dangerous, or remote characteristics and wherein the one or more predetermined actions are established based on the one or more hazardous, dangerous, or remote characteristics of the predefined geographic location;
storing the device management policy in the memory storage of the mobile device;
determining if the mobile device is in the predefined geographic location;
thereafter, if the mobile device is in the predefined geographic location, accessing the device management policy stored in the memory storage; and
causing the mobile device to perform the one or more predetermined actions as defined by the device management policy associated with the predefined geographic location.

2. The system of claim 1, wherein the predefined geographic location is an area having defined boundaries.

3. The system of claim 1, wherein the device management policy comprises a configuration data file.

4. The system of claim 1, wherein the one or more hazardous, dangerous, or remote characteristics indicate one or more of: risk of explosion, risk of accidental damage, risk to life, and availability of communication channels associated with the predefined geographic location.

5. The system of claim 4 wherein the one or more predetermined actions are established to reduce risk of explosion, reduce risk of accidental damage, reduce risk to life, identify communication channels available within the predefined geographic location, and maintain communication between the user, the mobile device, and a remote server.

6. The system of claim 1, wherein the one or more predetermined actions are further based on one or more of: the characteristics of the mobile device, the identity of the user, the number of personnel other than the user working in the predefined geographic location, the time of day, the date, the amount of time the user has been in the predefined geographic location, whether there has been a successful communication between the mobile device and a remote server, an amount of time that has elapsed since the successful communication, whether there has been input received by the mobile device from the user, and an amount of time that has elapsed since the input was received by the mobile device from the user.

7. The system of claim 1, wherein the one or more predetermined actions comprise one or more of: placing the mobile device in a hibernation state, placing the mobile device in a low power setting, causing the mobile device to send a data communication to a remote server, determining a preferred communication channel for sending the data communication to the remote server, requesting that the mobile device receive an input from the user, placing the mobile device in a normal operating state, determining battery life of the mobile device, activating an emergency strobe light on the mobile device, and determining if the mobile device is still in the predefined geographic location.

8. The system of claim 1, wherein determining if the mobile device is in the predefined geographic location is based on the global positioning system (GPS) coordinates of the mobile device and of the predefined geographic location.

9. The system of claim 1, wherein determining if the mobile device is in the predefined geographic location is based on input received by the mobile device from a remote server.

10. The system of claim 1, wherein determining if the mobile device is in the predefined geographic location is based on input received by the mobile device from the user.

11. The system of claim 1, wherein determining if the mobile device is in the predefined geographic location is based on input received by the mobile device from sensors or transceivers associated with the predefined geographic location.

12. The system of claim 1 further comprising determining when the mobile device is entering or exiting the predefined geographic location.

13. The system of claim 1 wherein storing the device management policy in the memory storage of the mobile device comprises uploading the device management policy from the external database to the mobile device.

14. The system of claim 1 further comprising modifying the device management policy based on a change to the one or more hazardous, dangerous, or remote characteristics of the predefined geographic location.

15. The system of claim 14 further comprising uploading the modified device management policy from the external database to the mobile device.

16. The system of claim 1 wherein the device management policy further includes one or more predetermined actions to be performed by the mobile device when it has been determined that the mobile device has exited the predefined geographic location.
